(19) United States
(12) Patent Application Publication
(10) Pub. No.: US 2011/0018985 A1
(43) Pub. Date: Jan. 27, 2011

(54) Hair-cutting systems with visualization devices

(76) Inventor: Linlin C. Zhu, Poughkeepsie, NY (US)

Correspondence Address: Linlin C. Zhu, 93 Autumn Dr., Poughkeepsie, NY, 12603, US

(21) Appl. No.: 12/460,660

(22) Filed: Jul. 23, 2009

(51) Int. Cl. H04N 7/18

(52) U.S. Cl. 348/61; 348/E07.085

(57) ABSTRACT

Hair-cutting systems with a visualization device are disclosed in present invention. The air-cutting systems include a video camera and a lighting device attached to an electrical hair-cutting clipper. Such hair-cutting systems are designed for use by an individual in cutting his or her own hair, and also for use by one person to cut the hair of another.

### FIELD OF THE INVENTION

This invention relates to a hair-cutting system, and more particularly to a hair-cutting system or hair clipper with a visualization capability.

### BACKGROUND OF THE INVENTION

Electric hair clippers or trimmer are commonly used by stylists, barbers, or individuals for styling the hair of others. However, it is needed to provide a hair-cutting system or clipper (interchangeable here) designed specifically for self-cutting. One such self-cutting electric hair-cutting clipper (e.g., commonly-assigned U.S. Pat. No. 7,281,461, to McCambridge et al, issued on Oct. 16, 2007, and incorporated by reference herein) provides effective guiding of hair into or retaining of hairs in a cutting zone of a bladeset and easy holding capability of a hair clippers. However, '461 patent does not provide visualization capability. Although with helping of mirror a person can see partially his or her hair during self-cutting process, it is difficult to cut and style his or her hair on the backside and the top of his or her head. To address this problem, this is a need for improving visualization capability of a hair-cutting clipper.

### SUMMARY OF THE INVENTION

To address the needs described above, the present invention disclosed a hair-cutting system with a visualization device that includes a video camera and a lighting device attached to an electrical hair-cutting clipper. More specifically, said hair-cutting system includes at least one video camera, at least one display device, at least one hair-cutting clipper, at least one video-device-holder which holds said video camera and said hair-cutting clipper together. Such hair-cutting systems are designed for use by an individual in cutting his or her own hair, and also for use by one person to cut the hair of another.

One can use the hair-cutting system proposed in present disclosure during his/her self haircutting, as shown in FIG. 1, especially cutting the hair he/she usually cannot see from a mirror such as the hair on the backside or the top of his/her head. For example, one activates the video camera and the display in present disclosure by plugging them into electrical power outlets and then connects the video camera with the display so that the pictures taken by the video camera can be shown on the display. When he or she is cutting his or her hair, the video camera is taking video or pictures at the same time. He/she can see the video or pictures from the display in his/her front, which can help him/her to create hairstyle that he/she wants.

### BRIEF DESCRIPTION OF THE DRAWINGS

FIG. 1 shows an example how to use the present hair-cutting system.

FIG. 2 is the present hair-cutting system includes a video device, an illumination device, a hair-cutting clipper, video-device-holder which holds said video device and said hair-cutting clipper, and a display.

FIG. 3 shows the present hair-cutting system that includes: a video device; a video-device-holder which uses velcro to hold the video device; the video-device-holder comprising a adjustable arm; an illumination device; a hair-cutting clipper; a computer or a laptop comprising at least one display device.

FIG. 4 is the present hair-cutting system includes a video device; a hair-cutting clipper; a video-device-holder which holds said video device and said hair-cutting clipper together; an illumination device; a computer or a laptop comprising at least one display device. Said video-device-holder comprising a fixed arm that is preferably located the bottom area of said hair-cutting clipper.

FIG. 5 is the present hair-cutting system includes a video device; a hair-cutting clipper; a video-device-holder which holds said video device and said hair-cutting clipper together; an illumination device; a computer or a laptop comprising at least one display device. Said video-device-holder comprising a fixed arm that is preferably located the top area of said hair-cutting clipper.

### DETAILED DESCRIPTION OF THE PREFERRED EMBODIMENT

Hair-cutting systems with visualization devices are disclosed. One can use the hair-cutting systems to cuts his/her own hair. He or she can use the visualization devices to watch a video or pictures in the area where usually cannot be seen when he or she cuts his/her own hair such as the backside or the top of his or her head. It is very helpful for a person who wants to get hair cut and to create any hairstyle by his or her own and improve hair cut quality. It is also useful for a customer to monitor his/her hairstyle when he or she gets a hair cut from a barber.

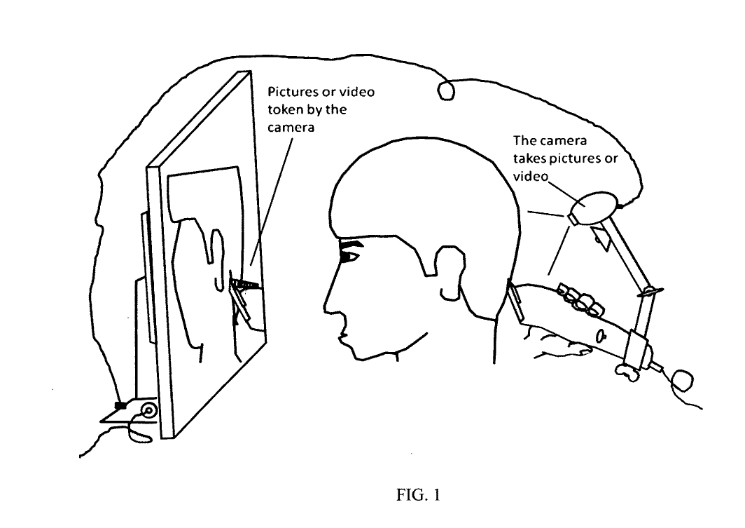

FIG. 1 is a schematic for using a haircutting system. One can use the haircutting system proposed in present disclosure to cut his/her own hair, especially cutting the hair he or she cannot see from a mirror such as the hair on the backside or the top of his or her head. For example, one connects the video camera with a display so that the video or pictures taken by the video camera can be shown on the display. When he/she is cutting his/her own hair, the video camera takes video or pictures at the same time. He/she can see the video or pictures from the display in his/her front, which can help him/her to create hairstyle that he/she wants or improve hair cut quality.

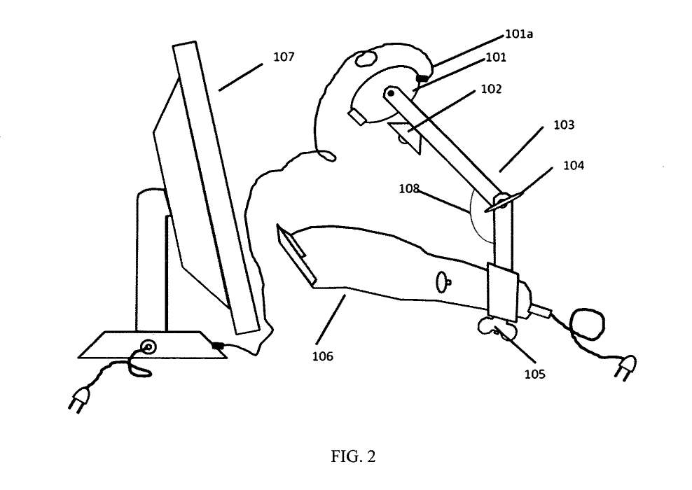

As shown in FIG. 2, in one embodiment, a hair-cutting system includes a video device of 101, an illumination device of 102, a video-device-holder of 103 which holds both said video device, a hair-cutting device of 106, and a display of 107. A cable 101a connecting said video and said display device. The video-device-holder of 103 holds the video device of 101 at one end and holds the hair-cutting device of 106 at another end. The video-device-holder 103 comprises, in one embodiment, an adjustable arm of 103 and a screw 104 that is used to adjust the angle 108 by loosing and tightening the screw 104. One embodiment, by adjusting the angle of 108 the video device 101 and illumination device 102 preferably focus on the area where the hair is being cutting. In another embodiment, the video-device-holder 103 is foldable.

In one embodiment, during a process of a hair cutting, the video device 101 takes video or pictures of the area where the hair is being cutting and transmits the video or pictures to the display 107. In another embodiment, during a process of a hair cutting, the video device 101 takes video or pictures of the area where the hair is being cutting and transmits the video or pictures to a computer and then to the display 107. In one embodiment, a screw 105 on the video-device-holder 103 is used to mount the video-device-holder 103 to the hair-cutting device 106.

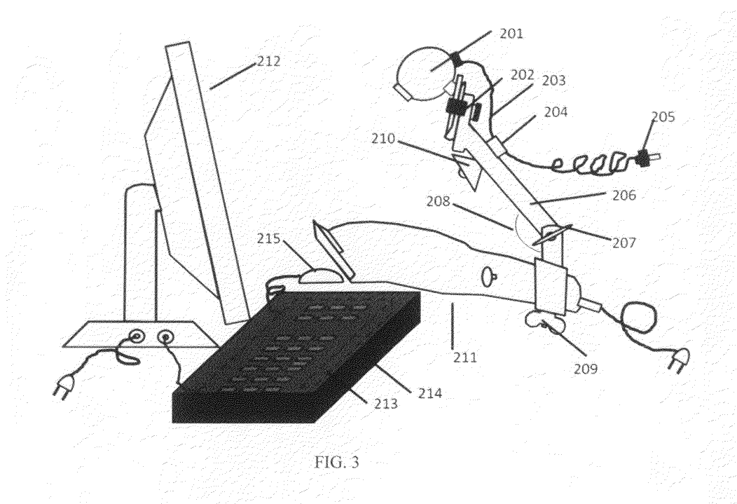

In another embodiment, shown in FIG. 3, a hair-cutting system includes: a video device 201; a video-device-holder 202 which in one embodiment uses velcro to hold the video device; a cable 203 for video device; a holder 204 for holding the cable 203; a plug 205 of video device 201 to connect the computer 212; the video-device-holder 202 comprising a adjustable arm 206; an adjustable angle 208 in the adjustable arm 206; a screw 207 used to adjust the angle of 208; a mounting screw 209 in the video-device-holder 202; an illumination device 210; a hair-cutting device 211; a computer or a laptop 212 comprising at least one display device; a keyboard 213 of the computer or laptop (in dashed line or covered by the cover of 214); keyboard cover 214; and a computer mouse 215.

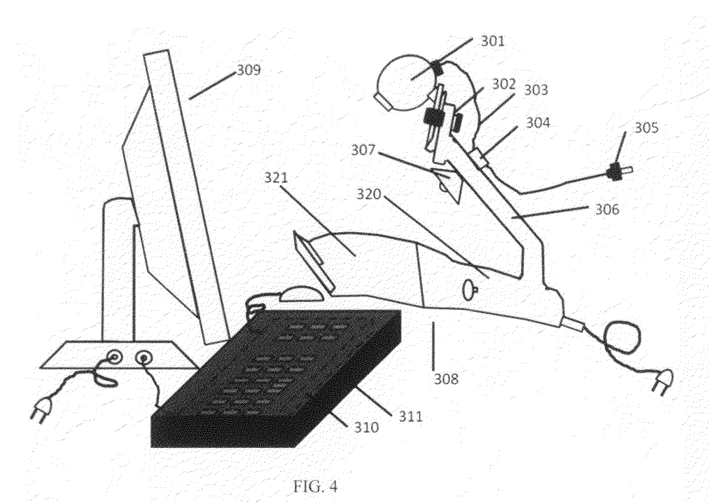

In yet another embodiment, shown in FIG. 4, a hair-cutting system includes: a video device 301; a video-device-holder 302 which in one embodiment uses velcro to hold the video device; a cable 303 for video device; a holder 304 for holding the cable 303; a plug 305 of video device 301 to connect the computer 309; an illumination device 307; a hair-cutting device 308; a computer or a laptop 309 comprising at least one display device; a keyboard 310 of the computer or laptop (in dashed line or covered by the cover 311); and a keyboard cover 311. The video-device-holder 302 comprising a fixed arm 306 that is preferably located the bottom area 320 of the hair-cutting device 308.

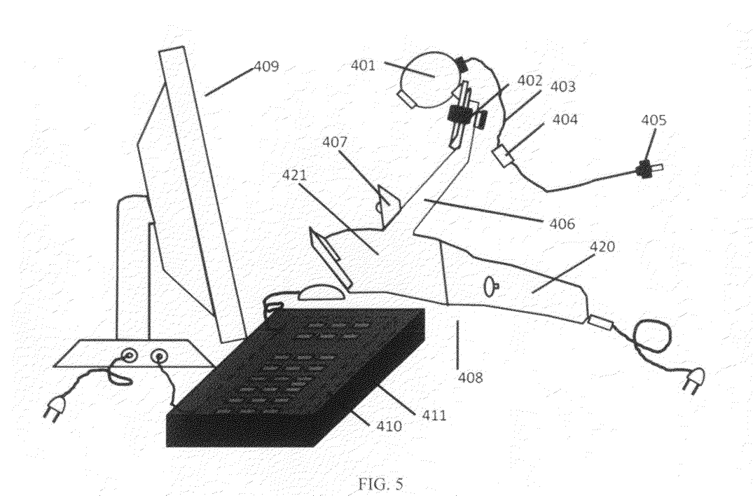

In further another embodiment, shown in FIG. 5, a haircutting system includes: a video device 401; a video-device-holder 402; a cable of the video device 403; a holder 404 of cable 203; a plug 405 of video device 401 to a computer 409; a supporting arm 406 of the video-device-holder; an illumination device 407; a hair-cutting device 408; a display device and computer 409; a keyboard 410 of a computer or laptop (in dashed line or, covered by the cover 411); a keyboard cover 411 to protect the computer or laptop keyboard 410 during haircut; a bottom part 420 of the hair-cutting device 408; and a top part 421 of the hair-cutting device 408. The video-device-holder 402 comprising a fixed arm 406 that is preferably located the top area 421 of the hair-cutting device 408.

What is claimed is:

1. A haircutting system comprising:
at least one video device;
at least one hair-cutting device;
at least one video-device-holder which holds said video device and is mounted
on said hair-cutting device; and
at least one display device.

2. The haircutting system of claim 1, wherein said at least one video device comprises at least one video camera.

3. The haircutting system of claim 1, wherein said at least one video device comprises an illumination device.

4. The haircutting system of claim 3, wherein said illumination device comprises lamp.

5. The haircutting system of claim 3, wherein said illumination device comprises at least one light ball and a focus lens or a focus reflector.

6. The haircutting system of claim 1, wherein said at least one display device comprises at least one light-emitting diode (LED) display or at least one Liquid Crystal Display (LCD) or at least one Cathode Ray Tube (CRT) display or at least one Plasma Screen Display and a processor.

7. The haircutting system of claim 1, wherein said at least one video device transmit video and picture signal to said at least one display device by a cable or wireless signals.

8. The haircutting system of claim 1, wherein said at least one video device comprises a wireless transmitter.

9. The haircutting system of claim 1, wherein said at least one video-device-holder comprises a holder of said video device and a fixed or an adjustable arm between said video device and said hair-cutting device.

10. The haircutting system of claim 1, wherein said at least one hair-cutting device is a hair clipper or an electrically powered hair trimmer.

11. A haircutting visualization device comprising:
at least one video-device;
at least one video-device-holder which holds said video-device; and
at least a display device.

12. The haircutting visualization device of claim 11, wherein said at least one video-device comprises at least a video camera.

13. The haircutting visualization device of claim 11, wherein said at least one video-device comprises an illumination device.

14. The haircutting visualization device of claim 13, wherein said illumination device comprises a light ball and a focus lens or a focus reflector.

15. The haircutting visualization device of claim 11, wherein said at least one display device comprises a processor and a screen display.

16. The haircutting visualization device of claim 11, wherein said at least one video-device transmit video and picture signal to said at least one display device by cable or wireless signals.

17. The haircutting visualization device of claim 11, wherein said video-device comprises a wireless transmitter.

18. The haircutting visualization device of claim 11, wherein said at least one video-device-holder comprises:
an arm;
a video-device holder at one end of said arm; and
a hair-cut-device holder at another end of said arm.

19. The haircutting visualization device of claim 18, wherein said video-device holder comprises a velcro or at least a mounting screw.

20. The haircutting visualization device of claim 18, wherein said hair-cut-device holder comprises a velcro or at least a mounting screw.
